(19) United States
(12) Patent Application Publication
(10) Pub. No.: US 2013/0084737 A1
(43) Pub. Date: Apr. 4, 2013

(54) ELECTRICAL CONNECTOR

(71) Applicants: Chao Wen Cai, Guangzhou (CN); Yong Quan Wu, Guangzhou (CN)

(72) Inventors: Chao Wen Cai, Guangzhou (CN); Yong Quan Wu, Guangzhou (CN)

(73) Assignee: LOTES CO., LTD., Keelung (TW)

(21) Appl. No.: 13/397,472

(22) Filed: Feb. 15, 2012

(30) Foreign Application Priority Data
Sep. 30, 2011 (CN) 201120368420.7

(51) Int. Cl. H01R 13/73

(52) U.S. Cl. 439/573

(57) ABSTRACT

An electrical connector includes an electrical connecting base, a press cover, a fastening member and at least one thrust member. The press cover covers on the electrical connecting base, and substantially horizontally placed. A fastening portion and a pivoting portion are respectively formed on two opposite ends of the press cover.

The press cover is opened or closed relative to the electrical connecting base around the pivoting portion. The fastening member correspondingly presses against the fastening portion of the press cover when the press cover is horizontally placed. The at least one thrust member urges against the press cover upwards. When the fastening member is released from pressing against the fastening portion, the press cover is urged to pop up, so that an operating space is formed below the press cover, which is sufficient for an operator to open the press cover manually.

### CROSS-REFERENCE TO RELATED APPLICATIONS

This non-provisional application claims priority under 35 U.S.C. §119(a) on Patent Application No. 201120368420.7 filed in P.R. China on Sep. 30, 2011, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention generally relates to an electrical connector, and more particularly to an electrical connector for electrically connecting a chip module to a circuit board.

### BACKGROUND OF THE INVENTION

Currently, in the industry, for an electrical connector commonly used for bearing a chip module, a fastener is equipped thereon which has a seat for receiving the electrical connector. A press cover is provided which substantially horizontally placed on the seat to cover the electrical connector. One end of the press cover is provided with a pivoting end pivoted to the seat. The seat is pivotally provided with a fastening member. After the press cover is closed, the fastening member presses against the press cover, so that the press cover provides a proper pressing force for the chip module. For the above structure, in operation, when intending to open the press cover to place or replace the chip module, an operator needs to open the fastening member first to release the fastening member from pressing against the press cover, and then open the press cover with hands to perform the replacement operation.

However, for the above structure, after the fastening member is released from pressing against the press cover, as the press cover is horizontally placed on the seat, the operator intending to open the press cover has to put fingers between the press cover and the seat, applies a force to lift the press cover upwards from a bottom of the press cover, which is inconvenient and easily causes injuries of the fingers during operation.

Moreover, to enable the press cover to apply a uniform pressing force to the chip module, the fastening member is generally disposed at one end opposite to the pivoting end of the press cover, which is consistent with the direction of manually lifting up the press cover. That is, the fastening member is close to the press cover, and a gap formed between the two is small, which hinders the manual operation of the press cover. The fingers of the operator need to pass through the small gap first and then enter between the press cover and the seat, which increases the difficulty of opening the press cover and the risk of injuring the fingers.

To alleviate the above problems, in the industry, a rocker is pivoted to the press cover, so as to control opening and closing of the press cover relative to the electrical connector through the rocker. However, for the above structure, after releasing the fastening member from pressing against the press cover, the operator needs to further operate the rocker to open the press cover in order to take out or put in the chip module. As the operator uses the rocker to control opening of the press cover throughout the process, a too large force may be applied, so that the press cover is lifted excessively to collide with and damage electronic elements on a circuit board. Meanwhile, such an operating mode easily damages fine circuits in the circuit board, which not only shortens the service life of the product, but increases the cost for maintenance and replacement.

To avoid this risk, according to a standard operating process in the industry, the operator needs to control the rocker with one hand to open the press cover to a reasonable height allowing fingers to reach the bottom of the press cover, and then use the other hand to completely open the press cover by lifting, which requires using both hands throughout the process, making it inconvenient to open the press cover. In addition, as the procedure of operating the rocker and the procedure of lifting the press cover are required, the procedures also make it inconvenient to open the press cover.

Therefore, a heretofore unaddressed need exists in the art to address the aforementioned deficiencies and inadequacies.

### SUMMARY OF THE INVENTION

In one aspect, the present invention is directed to an electrical connector having a press cover which can be opened easily.

In one embodiment, an electrical connector according to the present invention includes an electrical connecting base, a press cover, a fastening member, and at least one thrust member. The press cover covered on the electrical connecting base, and substantially horizontally placed, in which a fastening portion and a pivoting portion are respectively formed on two opposite ends of the press cover. The press cover is opened or closed relative to the electrical connecting base around the pivoting portion. The fastening member correspondingly presses against the fastening portion of the press cover when the press cover is horizontally placed. The at least one thrust member urges against the press cover upwards, in which when the fastening member is released from pressing against the fastening portion, the press cover is urged to pop up, so that an operating space is formed below the press cover, which is sufficient for an operator to open the press cover manually. The electrical connector includes two thrust members symmetrically distributed.

The electrical connector further includes a seat. The seat is formed with a receiving space for receiving the electrical connecting base. The fastening member is pivoted to the seat, and the pivoting portion of the press cover is pivoted to the seat.

The thrust member is disposed on the seat.

Furthermore, the seat is provided with at least one locking member for fixing the seat to a circuit board. The thrust member is correspondingly pivotally sleeved to the locking member.

The thrust member has at least one stopping portion for limiting movement of the thrust member.

The stopping portion extends upwards from an edge of a bottom of the thrust member.

The seat is formed with a receiving slot for receiving the thrust member. The thrust member has a first stopping portion for urging against the seat upwards, and a second stopping portion respectively disposed at each of two sides of the first stopping portion to urge against an outer side edge of the seat to fix the thrust member.

In another embodiment, a third stopping portion for urging against the seat upwards is disposed on one side of the thrust member opposite to the first stopping portion.

The thrust member is closer to the pivoting portion than to the fastening portion.

The thrust member is formed by stamping a metal sheet.

The thrust member has an elastic arm extending upwards obliquely and towards the fastening portion to urge against the press cover.

The seat includes a protruding portion for being pivoted to the fastening member. The protruding portion is adjacent to the fastening portion of the press cover, and the press cover after popping up is higher than the protruding portion, so that the operating space is formed in a height direction between the press cover and the protruding portion.

As compared with the related art, in the electrical connector of the present invention, among other things, the at least one thrust member is used to urge against the press cover upwards. When the fastening member is released from pressing against the fastening portion of the press cover, the press cover is urged to pop up, so that an operating space is formed below the press cover, which is sufficient for an operator to open the press cover manually. Therefore, the operator can easily lift up the press cover manually by simply putting fingers into the operating space, which facilitates opening of the press cover. Moreover, as only one procedure of lifting up the press cover manually is required, it is convenient to open the press cover.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a three-dimensional exploded view of an electrical connector according to a first embodiment of the present invention;

FIG. 2 is a three-dimensional assembled view of the electrical connector according to the first embodiment of the present invention;

FIG. 3 is a three-dimensional view of a thrust member of the electrical connector according to the first embodiment of the present invention;

FIG. 4 is a cross-sectional view of the electrical connector according to the first embodiment of the present invention in which an electrical connecting base is not shown;

FIG. 5 is a cross-sectional view of a thrust member popping a press cover upwards in the electrical connector according to the first embodiment shown in FIG. 4;

FIG. 6 is a partial three-dimensional exploded view of an electrical connector according to a second embodiment of the present invention; and

FIG. 7 is a side assembled view of the electrical connector according to the second embodiment shown in FIG. 6.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

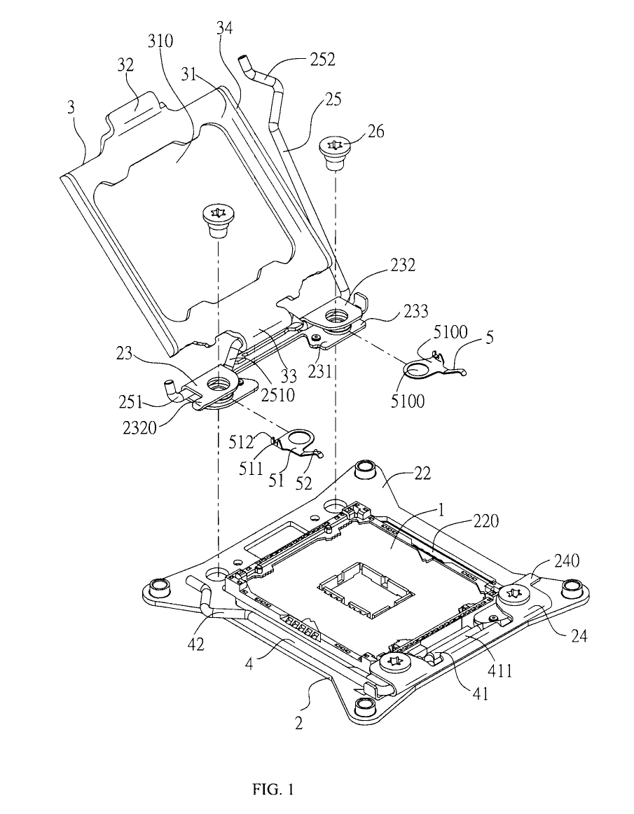

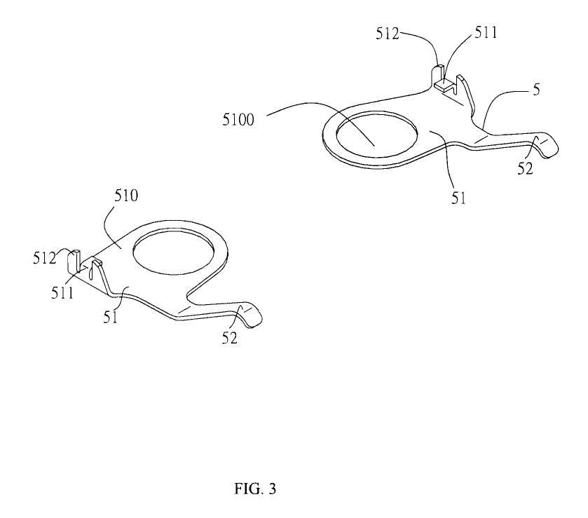

Referring to FIGS. 1-5, an electrical connector according to one embodiment of the present invention is used for electrically connecting a chip module (not shown) to a circuit board (not shown), and includes an electrical connecting base 1, a seat 2, a press cover 3, a fastening member 4 and at least one thrust member 5.

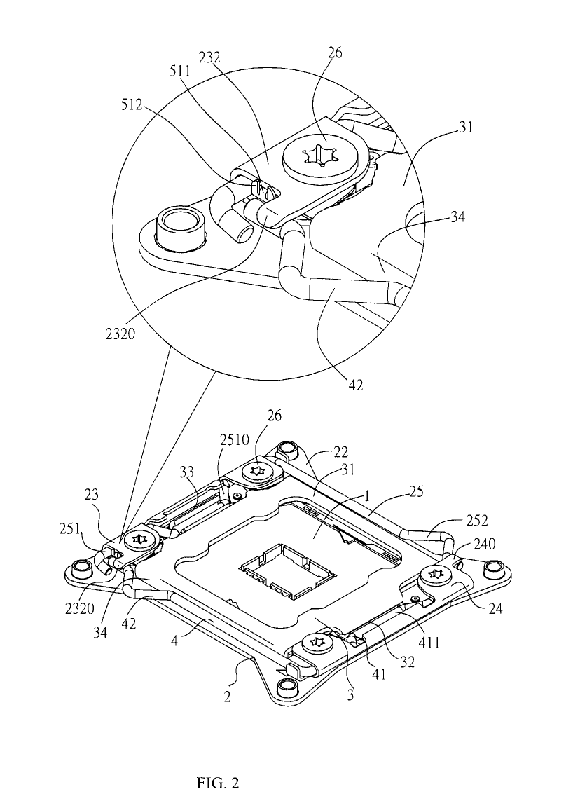

Referring to FIG. 1, the electrical connecting base 1 is used for bearing the chip module (not shown) to achieve the electrical conduction between the chip module (not shown) and the circuit board (not shown). Referring to FIG. 1 and FIG. 2, the seat 2 surrounds the electrical connecting base 1. The seat 2 includes a bottom plate 22, a first protruding portion 23 and a second protruding portion 24 located on the bottom plate 22, and a rocker 25 pivoted to the first protruding portion 23. The seat 2 is further provided with four locking members 26 (in this embodiment, the locking members 26 are screws). Two of the locking members 26 pass through the first protruding portion 23, the bottom plate 22 and holes in the circuit board (not shown), and the other two locking members 26 pass through the second protruding portion 24, the bottom plate 22 and holes in the circuit board (not shown), so as to fix the seat 2 to the circuit board (not shown).

Referring to FIG. 1, the bottom plate 22 is in a flat plate shape, and is provided with a receiving space 220 in the center for receiving the electrical connecting base 1.

Referring to FIG. 1 and FIG. 2, the first protruding portion 23 is located behind the electrical connecting base 1, and includes a flat plate portion 231 and an extending portion 232 bent and extending upwards from the flat plate portion 231 and then forwards along a horizontal direction. A receiving slot 233 is formed between the flat plate portion 231 and the extending portion 232. The receiving slot 233 is in communication with the receiving space 220. A first hook 2320 is provided at a left side of the extending portion 232.

Referring to FIG. 1 and FIG. 2, the second protruding portion 24 is located in front of the electrical connecting base 1. The second protruding portion 24 has substantially the same structure as the first protruding portion 23, a second hook 240 is provided at a right side of the second protruding portion 24.

Referring to FIG. 1, the rocker 25 includes a first rod 251 and a second rod 252 bent and extending from one end of the first rod 251. Referring to FIG. 2, the first rod 251 is pivoted to the first protruding portion 23. The first rod 251 has an engaging portion 2510 provided in the middle and eccentrically towards the press cover 3. The second rod 252 is fastened to the second hook 240 of the second protruding portion 24.

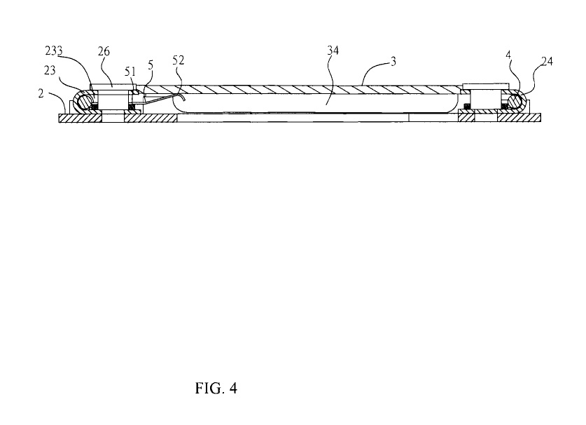

Referring to FIG. 1 and FIG. 2, the press cover 3 is formed by stamping a metal material. The press cover 3 has a main body 31 substantially in a flat plate shape. A through hole 310 is formed in the center of the main body 31 to correspondingly expose the chip module (not shown) to facilitate heat dissipation. One end of the main body 31 extends towards the second protruding portion 24 to form a fastening portion 32. One end of the main body 31 opposite to the fastening portion 32 extends towards the first protruding portion 23 to form a pivoting portion 33. The pivoting portion 33 is pivoted to the engaging portion 2510 of the rocker 25, and is capable of being opened or closed relative to the electrical connecting base 1. When in a closed state, the press cover 3 is covered on the electrical connecting base 1, substantially horizontally placed (as shown in FIG. 4), and used for pressing against the chip module (not shown). Each of the other two opposite ends of the main body 31 respectively extend downwards to form a side wall 34. The side walls 34 contact the bottom plate 22 of the seat 2 downwards.

Referring to FIG. 1, the fastening member 4 includes a pivot rod 41 and an operating rod 42 bent and extending from one end of the pivot rod 41. Referring to FIG.

2, the pivot rod 41 is pivoted to the second protruding portion 24. The pivot rod 41 has a pressing portion 411 provided in the middle and eccentrically towards the press cover 3. When the press cover 3 is substantially horizontally placed, the pressing portion 411 presses against the fastening portion 32 of the press cover 3, so that the press cover 3 is covered on the electrical connecting base 1. The operating rod 42 is fastened to the first hook 2320 of the first protruding portion 23.

Referring to FIGS. 1, 3 and 4, the thrust member 5 is formed by stamping a metal sheet. The thrust member 5 is located below the press cover 3, and is closer to the pivoting portion 33 than to the fastening portion 32. The thrust member 5 is used for urging against the press cover 3 upwards. In this embodiment, the electrical connector includes two thrust members 5 (alternatively, in other embodiments, the electrical connector may include one, three or more thrust members 5). The two thrust members 5 are symmetrically distributed relative to the pivoting portion 33, so as to ensure that when the thrust members 5 push the press cover 3, the press cover 3 receives a uniform force. The thrust member 5 has a mounting portion 51 and an elastic arm 52 extending obliquely upwards from the mounting portion 51 and towards the fastening portion 32.

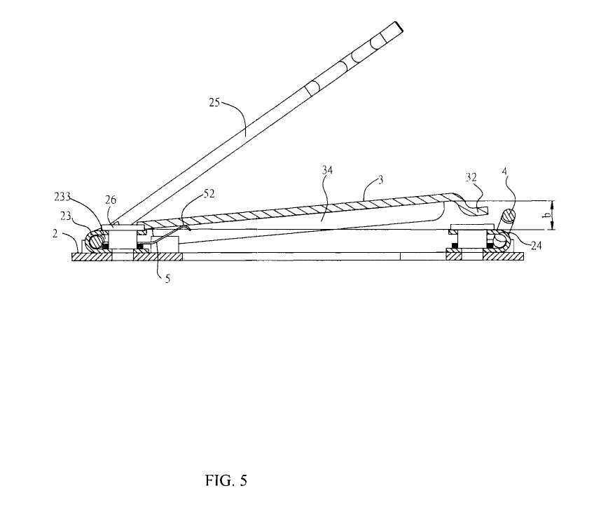

Referring to FIGS. 1, 2 and 3, the mounting portion 51 is received in the receiving slot 233. The mounting portion 51 includes a base portion 510 in a flat plate shape (that is, a bottom of the thrust member 5). The base portion 510 is provided with a combining hole 5100 for the locking member 26 to pass through, so that the mounting portion 51 is pivotally sleeved to the locking member 26, and dispose the thrust member 5 on the seat 2 (alternatively, in other embodiments, the thrust member 5 may also be disposed on the seat 2 in other manners). A first stopping portion 511 extends upwards from an edge of the base portion 510 and then extends substantially horizontally to urge against the extending portion 232, so as to limit displacement of the thrust member 5 in a vertical direction. A second stopping portion 512 extends upwards substantially vertically from an edge of the base portion 510 and each of the two sides of the first stopping portion 511 to urge against an outer side edge of the extending portion 232 of the first protruding portion 23, so as to limit displacement of the thrust member 5 in a horizontal direction, thereby positioning the thrust member 5, and preventing the thrust member 5 from moving along with rotation of the locking member 26 which may affect pushing of the thrust member 5 against the press cover 3. Referring to FIG. 4, when the press cover 3 is closed, the elastic arm 52 undergoes elastic deformation and is compressed due to a downward pressure of the press cover 3, and the elastic arm 52 urges against the press cover 3 upwards. Referring to FIG. 5, when the pressing portion 411 of the fastening member 4 is released from pressing against the fastening portion 32 of the press cover 3, the elastic arm 52 provides a pushing force by its elasticity to push the press cover 3 upwards, so that the press cover 3 is urged by the elastic arm 52 to pop up.

Referring to FIG. 5, in this embodiment, the press cover 3 after popping up is higher than the second protruding portion 24, so that an operating space b is further formed in a height direction between the main body 31 of the press cover 3 and the second protruding portion 24. Alternatively, the formation of the operating space b is not limited to the condition that the press cover 3 after popping up needs to be higher than the second protruding portion 24.

For the above structure, in operation, referring to FIG. 2, when needs to place the chip module (not shown) on the electrical connecting base 1 to achieve the electrical connection between the chip module (not shown) and the electrical connector, first, the second hook 240 is released from fastening the second rod 252 of the rocker 25. Then, the first hook 2320 is released from fastening the operating rod 42 of the fastening member 4, and the operating rod 42 is operated to rotate the pivot rod 41 of the fastening member 4, so that the pressing portion 411 releases the downward pressing force against the fastening portion 32 of the press cover 3. At this time, referring to FIG. 4 and FIG. 5, the elastic arm 52 of the thrust member 5 releases an upward pushing force accumulated by compression, which drives the press cover 3 to pop up and tilt upwards, so that the operating space b is formed in the height direction between the main body 31 of the press cover 3 and the second protruding portion 24. Thus, the operating space b is sufficient for the operator to completely open the press cover 3 manually.

However, as the press cover 3 is formed by a metal material, whose outer surface is usually treated, the press cover 3 is relatively smooth. Further, as the overall height of the press cover 3 is limited, it is not easy for the operator to directly grasp the two side walls 34 to open the press cover 3. Therefore, the operator may put fingers into the operating space b to further completely lift up the press cover 3 from a bottom of the main body 31 of the press cover 3, so that no obstruction exits above the electrical connecting base 1, and the chip module (not shown) can be mounted. After the chip module (not shown) is placed on the electrical connecting base 1, first, the operator operates the press cover 3 manually to enable the press cover 3 to rotate towards the electrical connecting base 1. After the press cover 3 contacts the thrust member 5, the operator applies a certain pressure to the press cover 3 to continue the operation until the press cover 3 is horizontally placed. At this time, due to the downward pressure of the press cover 3, the thrust member 5 undergoes elastic deformation and is compressed (as shown in FIG. 4). Then, the operating rod 42 of the fastening member 4 is rotated, so that the pressing portion 411 presses against the fastening portion 32, until the operating rod 42 is fastened to the first hook 2320. Next, the second rod 252 of the rocker 25 is rotated, so as to fasten the second rod 252 to the second hook 240. At this time, as the pressing portion 411 presses against the fastening portion 32, and the engaging portion 2510 presses against the pivoting portion 33, the press cover 3 presses downwards against the chip module (not shown), so that the chip module (not shown) tightly elastically urges against the electrical connecting base 1.

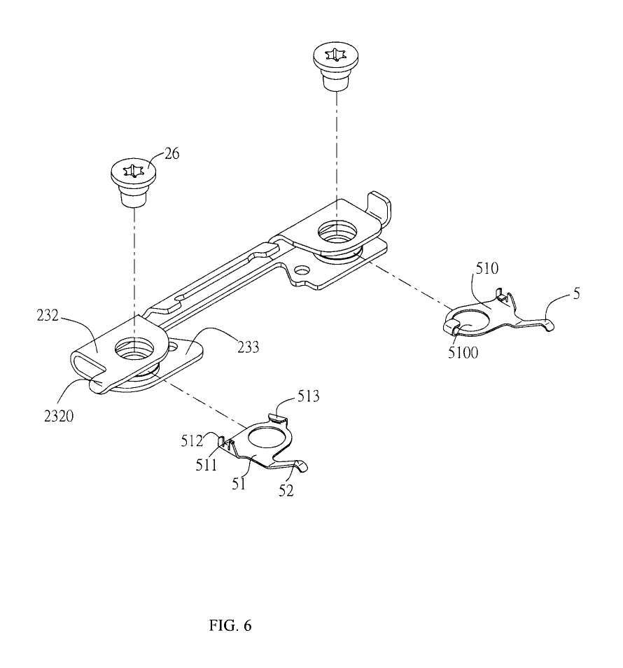

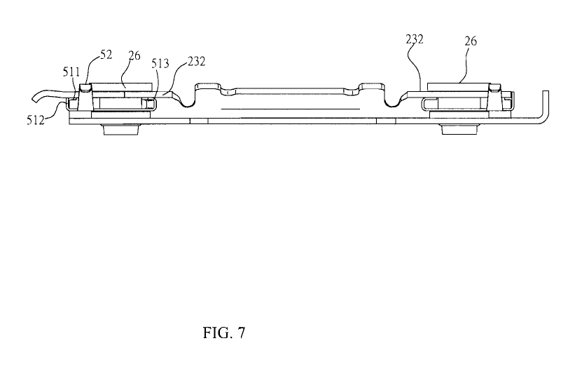

FIG. 6 and FIG. 7 show an electrical connector according to a second embodiment of the present invention, which is different from the first embodiment in that, in this embodiment, a third stopping portion 513 is additionally disposed on one side of the thrust member 5 opposite to the first stopping portion 511 to urge against the extending portion 232 upwards, so as to further limit displacement of the thrust member 5 in the vertical direction. The third stopping portion 513 extends upwards from an edge of the base portion 510 and then extends substantially horizontally.

In a third embodiment, if the press cover 3 after popping up is not higher than the second protruding portion 24 (not shown), the side walls 34 of the press cover 3 depart from the bottom plate 22 of the seat 2, so that an operating space is also formed in a height direction between the side walls 34 and the bottom plate 22. At this time, the operator can easily put fingers into the operating space to completely open the press cover 3 from the side walls 34.

In other alternative embodiments, after the press cover 3 pops up, the fastening portion 32 of the press cover 3 may be higher than the pressing portion 411 of the fastening member 4. At this time, an operating space is also formed in a height direction between the fastening portion 32 of the press cover 3 and the pressing portion 411 of the fastening member 4. The operator can easily put fingers into the operating space to operate the fastening portion 32, so as to completely open the press cover 3. Based on the above, the electrical connector of the present invention, among other things, has the following beneficial effects.

1. As the thrust member 5 urges against the press cover 3 upwards, when the pressing portion 411 of the fastening member 4 is released from pressing against the fastening portion 32 of the press cover 3, the press cover 3 is urged to pop up, so that the operating space b is formed below the press cover 3, which is sufficient for the operator to open the press cover 3 manually. At this time, the operator can easily completely open the press cover 3 manually by simply placing fingers in the operating space b, making it convenient to open the press cover 3. As only one procedure of manually lifting the press cover 3 is required, it is convenient to open the press cover 3.

2. As the two thrust members 5 are symmetrically distributed, it can be ensured that when the thrust members 5 push the press cover 3, the press cover 3 receives a uniform force.

3. As the thrust member 5 is closer to the pivoting portion 33 than to the fastening portion 32, when the press cover 3 pops up, the thrust member 5 is lower than the press cover 3, which can reduce the height of the thrust member 5 as compared with the case where the thrust member 5 is disposed close to the fastening portion 32 (in this case, the thrust member 5 is substantially at the same height as the press cover 3).

4. As the mounting portion 51 of the thrust member 5 is pivotally sleeved to the locking member 26, an edge of the press cover 3 adjacent to the locking member 26 is also urged by the thrust member 5 to move upwards, so that a gap exists between the locking member 26 and the edge of the press cover 3 adjacent to the locking member 26. In this way, the press cover 3 does not collide with the locking member 26 during rotation, thereby ensuring smooth rotation of the press cover 3.

5. The thrust member 5 has the first stopping portion 511, the second stopping portion 512 and the third stopping portion 513 extending upwards from edges of the base portion 510 (that is, the bottom of the thrust member 5) to urge against the extending portion 232 of the seat 2, so as to limit the displacement of the thrust member 5 in the vertical direction and the horizontal direction. As compared with the case where the overall thickness of the thrust member 5 is increased to urge against the extending portion 232, the thickness of the thrust member 5 can be reduced, thereby reducing the cost and making it easier to fabricate.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
(a) an electrical connecting base;
(b) a press cover, covered on the electrical connecting base, and substantially horizontally placed, wherein a fastening portion and a pivoting portion are respectively formed on two opposite ends of the press cover, and the press cover is opened or closed relative to the electrical connecting base around the pivoting portion;
(c) a fastening member, for correspondingly pressing against the fastening portion of the press cover when the press cover is horizontally placed; and
(d) at least one thrust member, for urging against the press cover upwards, wherein when the fastening member is released from pressing against the fastening portion, the press cover is urged to pop up, so that an operating space is formed below the press cover, which is sufficient for an operator to open the press cover manually.

2. The electrical connector according to claim 1, wherein the electrical connector comprises two thrust members symmetrically distributed.

3. The electrical connector according to claim 1, further comprising a seat, wherein the seat is formed with a receiving space for receiving the electrical connecting base, the fastening member is pivoted to the seat, and the pivoting portion of the press cover is pivoted to the seat.

4. The electrical connector according to claim 3, wherein the thrust member is disposed on the seat.

5. The electrical connector according to claim 3, wherein the seat is provided with at least one locking member for fixing the seat to a circuit board, and the thrust member is correspondingly pivotally sleeved to the locking member.

6. The electrical connector according to claim 1, wherein the thrust member has at least one stopping portion for limiting movement of the thrust member.

7. The electrical connector according to claim 6, wherein the stopping portion extends upwards from an edge of a bottom of the thrust member.

8. The electrical connector according to claim 3, wherein the seat is formed with a receiving slot for receiving the thrust member, and the thrust member has a first stopping portion for urging against the seat upwards, and a second stopping portion respectively disposed at two sides of the first stopping portion to urge against an outer side edge of the seat to fix the thrust member.

9. The electrical connector according to claim 8, wherein a third stopping portion for urging against the seat upwards is disposed on one side of the thrust member opposite to the first stopping portion.

10. The electrical connector according to claim 1, wherein the thrust member is closer to the pivoting portion than to the fastening portion.

11. The electrical connector according to claim 1, wherein the thrust member is formed by stamping a metal sheet.

12. The electrical connector according to claim 1, wherein the thrust member has an elastic arm extending upwards obliquely and towards the fastening portion to urge against the press cover.

13. The electrical connector according to claim 3, wherein the seat comprises a protruding portion for being pivoted to the fastening member, the protruding portion is adjacent to the fastening portion of the press cover, and the press cover after popping up is higher than the protruding portion, so that an operating space is formed in a height direction between the press cover and the protruding portion.
